(19) United States
(12) Patent Application Publication
(10) Pub. No.: US 2017/0115259 A1
(43) Pub. Date: Apr. 27, 2017

(54) HIGH PERFORMANCE LIQUID CHROMATOGRAPHY METHOD FOR ANALYZING IMAGING AGENT, PRECURSOR OF IMAGING AGENT, OR INTERMEDIATE OF IMAGING AGENT

(71) Applicant: INSTITUTE OF NUCLEAR ENERGY RESEARCH, ATOMIC ENERGY COUNCIL, EXECUTIVE YUAN, R.O.C., TAOYUAN CITY (TW)

(72) Inventors: KUEI-LIN LU, TAOYUAN CITY (TW); JHE-YU LIU, TAOYUAN CITY (TW); YU CHANG, TAOYUAN CITY (TW); CHENG-FENG HSU, TAOYUAN CITY (TW)

(21) Appl. No.: 14/919,859

(22) Filed: Oct. 22, 2015

(51) Int. Cl. G01N 30/74

(52) U.S. Cl. CPC G01N 30/74; G01N 2030/027

(57) ABSTRACT

A high performance liquid chromatography method of an imaging agent, a precursor of the imaging agent, or an intermediate of the imaging agent is revealed. Instead of using the same eluent, a first eluent with a lower proportion of methanol is used to elute target compounds. Then a second eluent having a higher ratio of methanol ranging from 95-99% is used to elute for at least 15 minutes. Next use the first eluent again to elute for at least 60 minutes. Thus the target compounds are retained stably in the column and retention time of respective reproductive characteristic peak is obtained.

### FIELD OF THE INVENTION

The present invention relates to an analysis method, especially to a high performance liquid chromatography (HPLC) method for analyzing an imaging agent, a precursor of the imaging agent, and an intermediate of the imaging agent.

### BACKGROUND OF THE INVENTION

Parkinson's disease is a degenerative disorder of the central nervous system. The disease results from the degeneration of the substantia nigra in the brain stem. The degeneration further causes the slow and steady loss of dopaminergic neurons in basal ganglia including putamen, caudate nucleus, etc. Thus the amount of dopamine in the synapse is decreased and causing gradual loss of movement. Dopamine transporter (DAT) is a transmembrane protein expressed in dopaminergic neuron. The amount of DAT correlates with the loss of dopaminergic neurons. [99mTc]TRODAT-1 is a useful imaging agent for dopamine transporters and is used to detect the amount of dopaminergic neurons in the brain. Thus whether motor neuron disorders are caused by degeneration of the dopaminergic neurons can be evaluated for differential diagnosis of the disease.

The manufacturing process of the imaging agent TRODAT-1 includes complicated steps. Not the intermediate of each step has the corresponding high performance liquid chromatography (HPLC) method. The lack of reproducibility in analysis results of the few analysis methods available now is caused by that low polar impurities are unable to be eluted during analysis.

In conventional HPLC methods, the eluent contains the same proportion of solvent. Although the time required for mobile phase optimization is reduced and continuous sample introduction is achieved, the low-polar impurities are unable to be eluted from the column and detected due to low polarity of the mobile phase. When a simple area percent is used to calculate the percentage purity, it is not a true purity value. The false positive result caused by the low-polar impurities is obtained. On the other hand, the low-polar impurities unable to be eluted and remaining in the column may cause obstruction or interference the following analysis. Thus the false negative result is got. There is room for improvement and a need to develop a new HPLC method for solving the problems mentioned above.

### SUMMARY

Therefore it is a primary object of the present invention to provide a high performance liquid chromatography (HPLC) method for analyzing an imaging agent, a precursor of the imaging agent, or an intermediate of the imaging agent in which a solution containing a high proportion of methanol is used for elution so as to reduce possibility of easily-retained substances remaining in the column.

It is another object of the present invention to provide a high performance liquid chromatography (HPLC) method for analyzing an imaging agent, a precursor of the imaging agent, or an intermediate of the imaging agent in which a detection wavelength of an ultraviolet (UV) detector set at 210 nm for detection of most of molecules is used to increase accuracy of the area percentage.

It is a further object of the present invention to provide a high performance liquid chromatography (HPLC) method for analyzing an imaging agent, a precursor of the imaging agent, or an intermediate of the imaging agent in which gradient elution is introduced to elute low-polar impurities by using eluent having higher proportions of methanol. The reliability of analysis results is further improved.

In order to achieve the above objects, a high performance liquid chromatography (HPLC) method for analyzing an imaging agent, a precursor of the imaging agent, or an intermediate of the imaging agent of the present invention is provided. The imaging agent has the following structural formula.

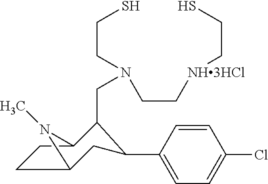

The high performance liquid chromatography (HPLC) method of the present invention includes the following steps. First set the imaging agent, a precursor of the imaging agent or an intermediate of the imaging agent into a chromatographic column. Then use a first eluent to elute the imaging agent, the precursor or the intermediate while the first eluent includes methanol and trifluoroacetic acid at a concentration of 0.5-1% by weight. The volume ratio of the methanol to the first eluent ranges from 5% to 70%. Next use a second eluent to elute the imaging agent, the precursor or the intermediate. The second eluent includes methanol and trifluoroacetic acid at a concentration of 0.5-1% by weight. The volume ratio of the methanol to the second eluent ranges from 95% to 99%. Then use the first eluent again to elute the imaging agent, the precursor or the intermediate. A UV detector is used to record a chromatogram during the elution.

### BRIEF DESCRIPTION OF THE DRAWINGS

FIG. 1 is a flow chart showing steps of an embodiment according to the present invention;

FIG. 2 is a HPLC chromatogram of an embodiment according to the present invention;

FIG. 3 is a HPLC chromatogram of another embodiment according to the present invention;

FIG. 4 is a HPLC chromatogram of a further embodiment according to the present invention;

FIG. 5 is a HPLC chromatogram of a further embodiment according to the present invention;

FIG. 6 is a HPLC chromatogram of a further embodiment according to the present invention;

FIG. 7 is a HPLC chromatogram of a further embodiment according to the present invention;

FIG. 8 is a HPLC chromatogram of a further embodiment according to the present invention;

FIG. 9 is a HPLC chromatogram of a further embodiment according to the present invention;

FIG. 10 is a HPLC chromatogram of a further embodiment according to the present invention; and

FIG. 11 is a HPLC chromatogram of a further embodiment according to the present invention.

### DETAILED DESCRIPTION

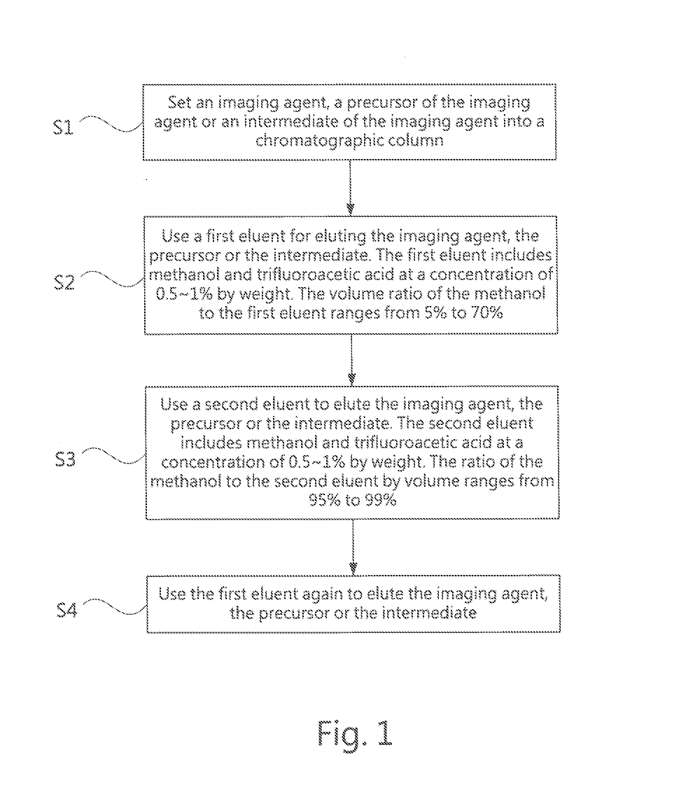

Refer to FIG. 1, a high performance liquid chromatography of an imaging agent, a precursor of imaging agent, or an intermediate of imaging agent includes the following steps.
Step S1: Set an imaging agent, a precursor of the imaging agent or an intermediate of the imaging agent into a chromatographic column;
Step S2: Use a first eluent for eluting the imaging agent, the precursor or the intermediate. The first eluent includes methanol and trifluoroacetic acid at a concentration of 0.5˜1% by weight. The volume ratio of the methanol to the first eluent ranges from 5% to 70%.
Step S3: Use a second eluent to elute the imaging agent, the precursor or the intermediate. The second eluent includes methanol and trifluoroacetic acid at a concentration of 0.5˜1% by weight. The ratio of the methanol to the second eluent by volume ranges from 95% to 99%.
Step S4: Use the first eluent again to elute the imaging agent, the precursor or the intermediate.

A UV detector is used to record a chromatogram during the elution.

During the elution, the eluent having the same proportion of solvents is not used continuingly. Firstly the first eluent with a lower ratio of methanol is used to elute target compounds. Then the ratio of methanol in solution is increased to 95-99% and the solution is used as a second eluent to elute for at least 15 minutes. Next the first eluent is used again to elute for at least 60 minutes so as to make the HPLC system turn back to the initial state stably. The reason that the first eluent is changed into the second eluent lies in the use of the UV detector. After the peak of the target compound being detected by the ultraviolet (UV) detector set at 210 nm, stop using the first eluent and start to use the second eluent.

The UV detector is set at 210 nm so as to make the area under the peak (given as area percentage) proportional to the amount of the main component in the solution get closer to the actual purity value. Benzene derivatives show absorption at 254 nm, so that testing personnel set the UV detector at 254 nm. However, not all impurities include benzene ring. That means not all impurities have absorption at 254 nm. Thus the UV detector of the present invention is set at 210 nm so as to detect most of molecules and improve accuracy of the area percentage.

Take the imaging agent TRODAT-1 (2-[[2-[[[3-(4-Chlorophenyl)-8-methyl-8-azabicyclo[3.2.1]-oct-2-yl]-methyl](2-mercaptoethyl)amino]ethyl]amino]ethanethiol-[1R-(exo-exo)]trihydrochloride) as an example for operations and analysis. The chromatographic column used is Merck Chromolith RP-18e. The present invention can be applied to analysis of final products, the precursor, and the intermediates generated during preparation of TRODAT-1.

In the step S1, the imaging agent, the precursor of the imaging agent or the intermediate of the imaging agent are produced during conventional manufacturing processes. The synthesis pathway of TRODAT-1 is shown by the following equation 1 and equation 2.

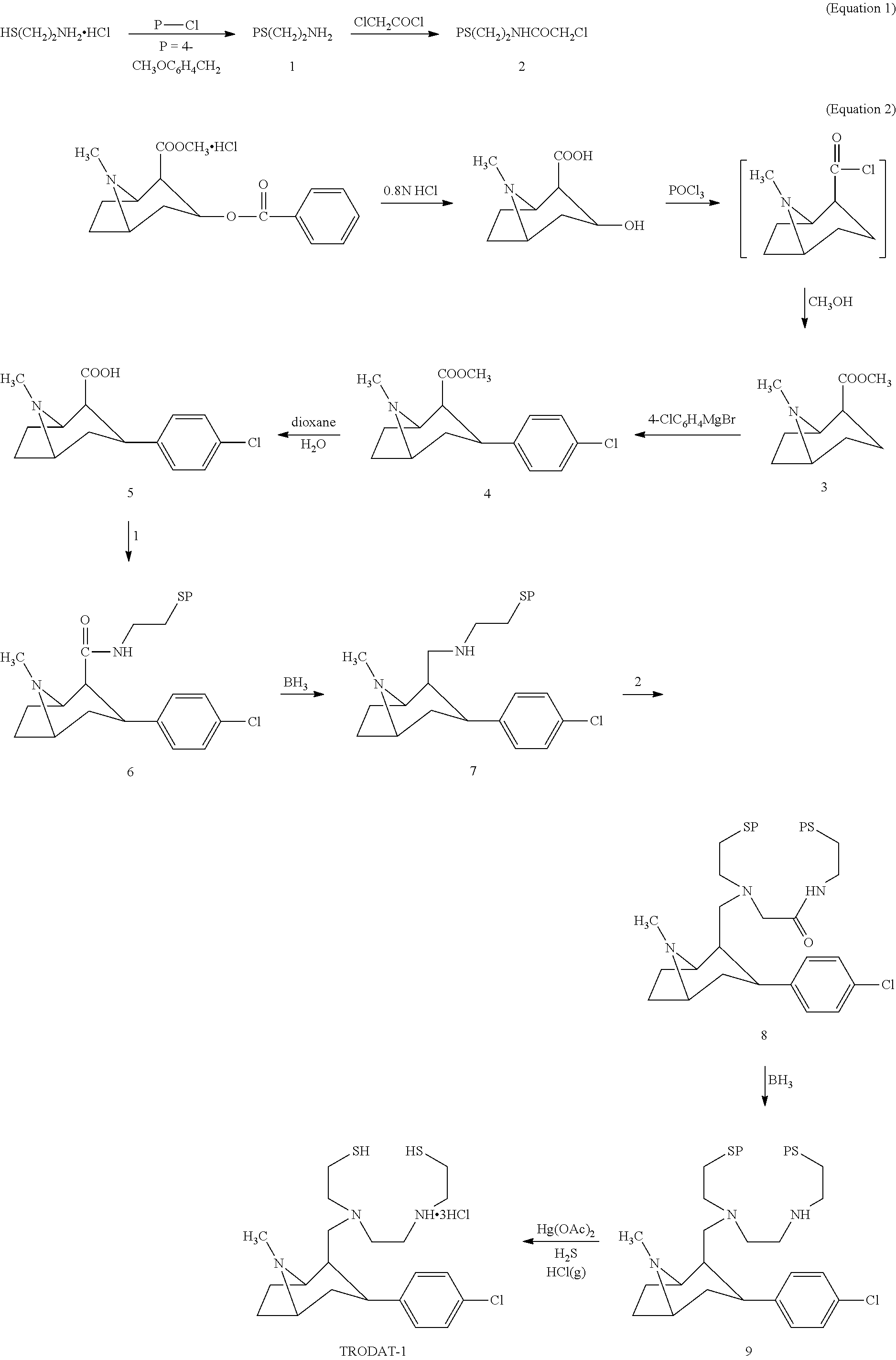

Take the intermediate 1 in the equation 1 as an example. The intermediate 1 is 2-(S-4-Methoxybenzyl) thioethylamine and having the following structural formula.

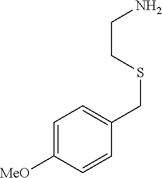 [SMILES: COc1ccc(CSCCN)cc1]

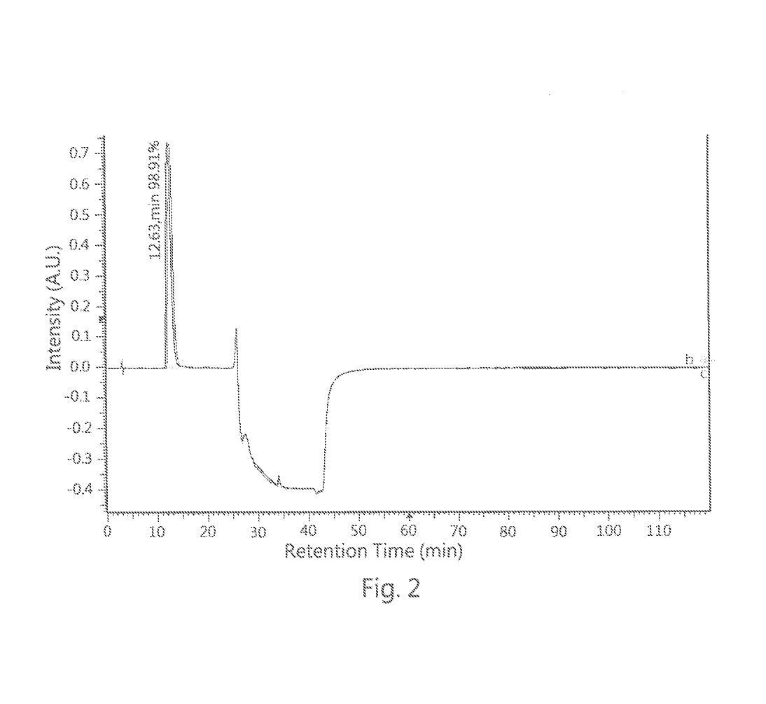

The operations and analysis of the intermediate 1 are performed in a 2.0 ml amber glass vial. Weight 4 mg intermediate 1 accurately and put the intermediate 1 into the 2.0 ml amber glass vial. Then add 1.8 ml methanol (HPLC grade). The initial condition is that methanol-0.1% trifluoroacetic acid solution (aqueous) (20:80, v/v) is used as the first eluent. Wait for 20 minutes. Then the first eluent is replaced by a second eluent, methanol-0.1% trifluoroacetic acid solution (aqueous) (99:1, v/v) in 30 seconds and wait for 15 minutes. Next the second eluent is changed into the first eluent- methanol-0.1% trifluoroacetic acid solution (aqueous) (20:80, v/v) in 30 seconds and wait for 84 minutes at last. The retention time of a characteristic peak (intermediate 1) is about 12.63 minutes. Refer to data in the following table 1 and the result in FIG. 2.

TABLE 1

| Time(min) | 0.5 | 20.0 | 20.5 | 35.5 | 36.0 | 120.0 |
|---|---|---|---|---|---|---|
| Trifluoroacetic acid | 80% | 80% | 1% | 1% | 80% | 80% |
| Methanol | 20% | 20% | 99% | 99% | 20% | 20% |

Take the precursor 2 in the equation 1 as an example. The precursor 2 is N-[2-(S-4-Methoxybenzyl)thioethyl]-2-chloroacetamide and having the following structural formula.

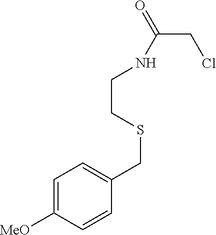 [SMILES: COc1ccc(CSCCNC(=O)CCl)cc1]

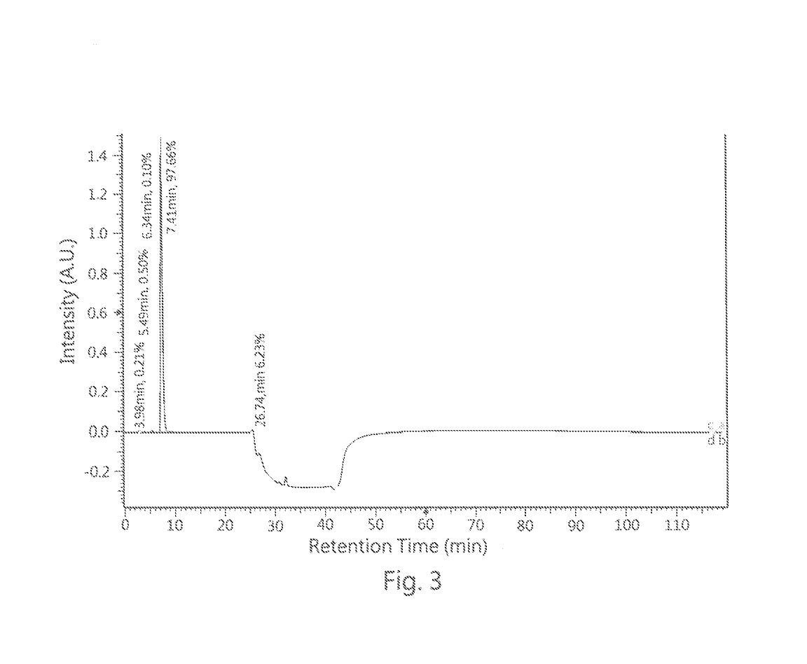

The operations and analysis of the precursor 2 are performed in a 2.0 ml amber glass vial. Weight 4 mg precursor 2 accurately, put the intermediate into the 2.0 ml amber glass vial, and then add 1.8 ml methanol (HPLC grade). The initial condition is that methanol-0.1% trifluoroacetic acid solution (aqueous) (50:50, v/v) is used as the first eluent. Wait for 20 minutes. Then the first eluent is replaced by a second eluent, methanol-0.1% trifluoroacetic acid solution (aqueous) (99:1, v/v) in 30 seconds and wait for 15 minutes. Next the second eluent is changed into the first eluent-methanol-0.1% trifluoroacetic acid solution (aqueous) (50:50, v/v) in 30 seconds and wait for 84 minutes at last. The retention time of a characteristic peak (precursor 2) is about 7.41 minutes. Refer to data in the following table 2 and the result in FIG. 3.

TABLE 2

| Time (min) | 0.5 | 20.0 | 20.5 | 35.5 | 36.0 | 120.0 |
|---|---|---|---|---|---|---|
| Trifluoroacetic acid | 50% | 50% | 1% | 1% | 50% | 50% |
| Methanol | 50% | 50% | 99% | 99% | 50% | 50% |

Take the intermediate 3 in the equation 2 as an example. The intermediate 3 is (R)-(−)-Anhydroecgonine methyl ester and having the following structural formula.

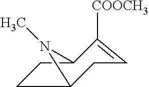

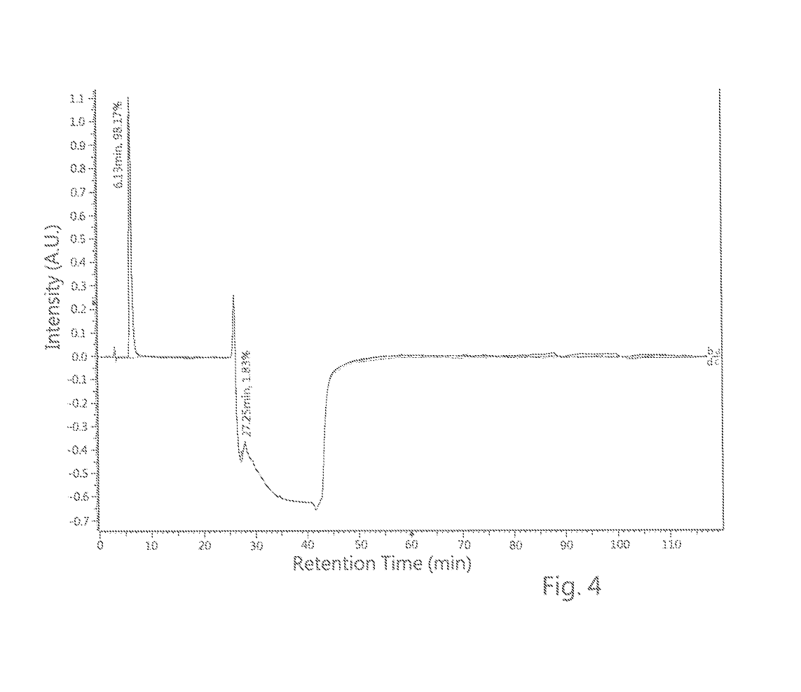

The operations and analysis of the intermediate 3 are performed in a 2.0 ml amber glass vial. Weight 4 mg intermediate 3 accurately and put the intermediate 3 into the 2.0 ml amber glass vial. Then add 1.8 ml methanol (HPLC grade). The initial condition is that methanol-0.1% trifluoroacetic acid solution (aqueous) (5:95, v/v) is used as the first eluent. Wait for 20 minutes. Then the first eluent is replaced by a second eluent, methanol-0.1% trifluoroacetic acid solution (aqueous) (99:1, v/v) in 30 seconds and wait for 15 minutes. Next the second eluent is changed into the first eluent-methanol-0.1% trifluoroacetic acid solution (aqueous) (5:95, v/v) in 30 seconds and wait for 84 minutes at last. The retention time of a characteristic peak (intermediate 3) is about 6.13 minutes. Refer to data in the following table 3 and the result in FIG. 4.

TABLE 3

| Time (min) | 0.5 | 20.0 | 20.5 | 35.5 | 36.0 | 120.0 |
|---|---|---|---|---|---|---|
| Trifluoroacetic acid | 95% | 95% | 1% | 1% | 95% | 95% |
| Methanol | 5% | 5% | 99% | 99% | 5% | 5% |

Take the intermediate 4 in the equation 2 as an example. The intermediate 4 is 2β-Carbomethoxy-3β-(4-chlorophenyl)tropane and having the following structural formula.

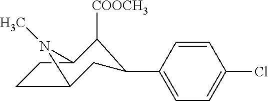 [SMILES: COC(=O)C1C(c2ccc(Cl)cc2)CC2CCC1N2C]

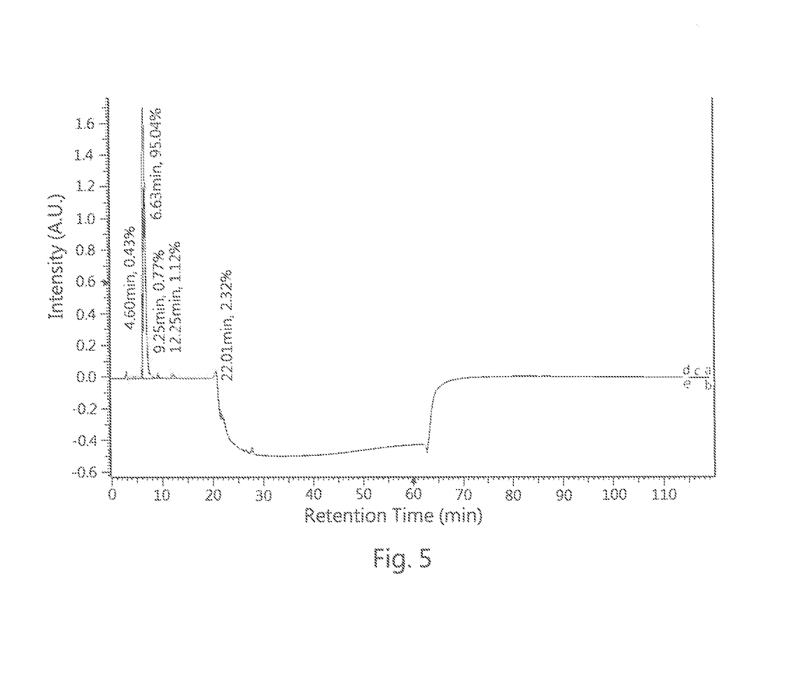

The operations and analysis of the intermediate 4 are performed in a 2.0 ml amber glass vial. Weight 2.7 mg intermediate 4 accurately and put the intermediate 4 into the 2.0 ml amber glass vial. Then add 1.8 ml methanol (HPLC grade). The initial condition is that methanol-0.1% trifluoroacetic acid solution (aqueous) (40:60, v/v) is used as the first eluent. Wait for 15 minutes. Then the first eluent is replaced by a second eluent, methanol-0.1% trifluoroacetic acid solution (aqueous) (99:1, v/v), in 30 seconds and wait for 40 minutes. Next the second eluent is changed into the first eluent- methanol-0.1% trifluoroacetic acid solution (aqueous) (40:60, v/v) in 30 seconds and wait for 64 minutes at last. The retention time of a characteristic peak (intermediate 4) is about 6.63 minutes. Refer to data in the following table 4 and the result in FIG. 5.

TABLE 4

| Time (min) | 0.5 | 15.0 | 15.5 | 55.5 | 56.0 | 120.0 |
|---|---|---|---|---|---|---|
| Trifluoroacetic acid | 60% | 60% | 1% | 1% | 60% | 60% |
| Methanol | 40% | 40% | 99% | 99% | 40% | 40% |

Take the intermediate 5 in the equation 2 as an example. The intermediate 5 is 2β-Carboxy-3β-(4-chlorophenyl)tropane and having the following structural formula.

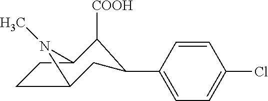 [SMILES: CN1C2CCC1C(C(=O)O)C(c1ccc(Cl)cc1)C2]

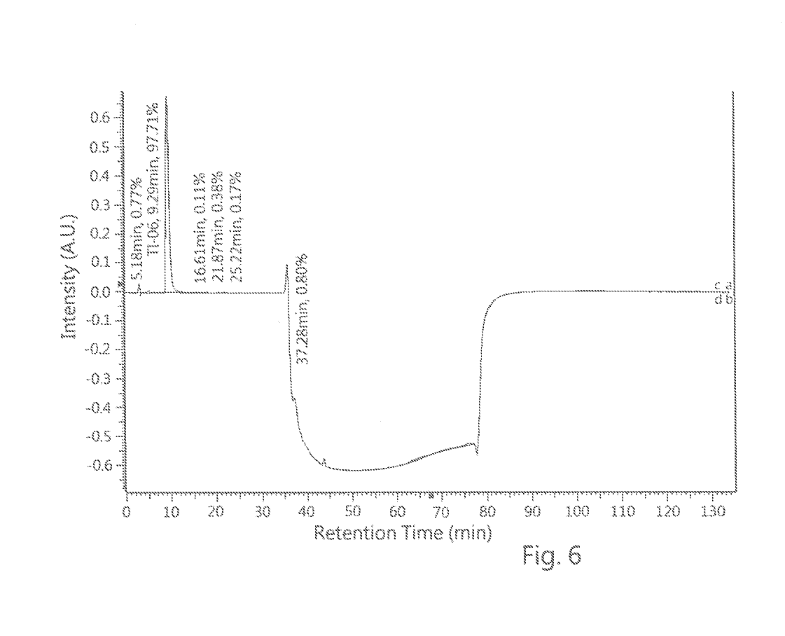

The operations and analysis of the intermediate 5 are performed in a 2.0 ml amber glass vial. Weight 4 mg intermediate 5 accurately and put the intermediate 5 into the 2.0 ml amber glass vial. Then add 1.8 ml methanol (HPLC grade). The initial condition is that methanol-0.1% trifluoroacetic acid solution (aqueous) (30:70, v/v) is used as the first eluent. Wait for 30 minutes. Then the first eluent is replaced by a second eluent, methanol-0.1% trifluoroacetic acid solution (aqueous) (99:1, v/v) in 30 seconds and wait for 40 minutes. Next the second eluent is changed into the first eluent- methanol-0.1% trifluoroacetic acid solution (aqueous) (30:70, v/v) in 30 seconds and wait for 64 minutes at last. The retention time of a characteristic peak (intermediate 5) is about 9.29 minutes. Refer to data in the following table 5 and the result in FIG. 6.

TABLE 5

| Time (min) | 0.5 | 30.0 | 30.5 | 70.5 | 71.0 | 135.0 |
|---|---|---|---|---|---|---|
| Trifluoroacetic acid | 70% | 70% | 1% | 1% | 70% | 70% |
| Methanol | 30% | 30% | 99% | 99% | 30% | 30% |

Take the intermediate 6 in the equation 2 as an example. The intermediate 6 is 3-(4-Chlorophenyl)-N-[2[S-(4-methoxybenzyl)thio]ethyl]-8-azabicyclo[3.2.1]-octane-2-carboxamide-[1R-(exo-exo)] and having the following structural formula.

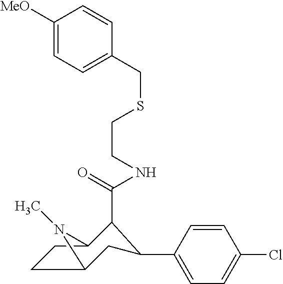 [SMILES: COc1ccc(CSCCNC(=O)C2C(c3ccc(Cl)cc3)CC3CCC2N3C)cc1]

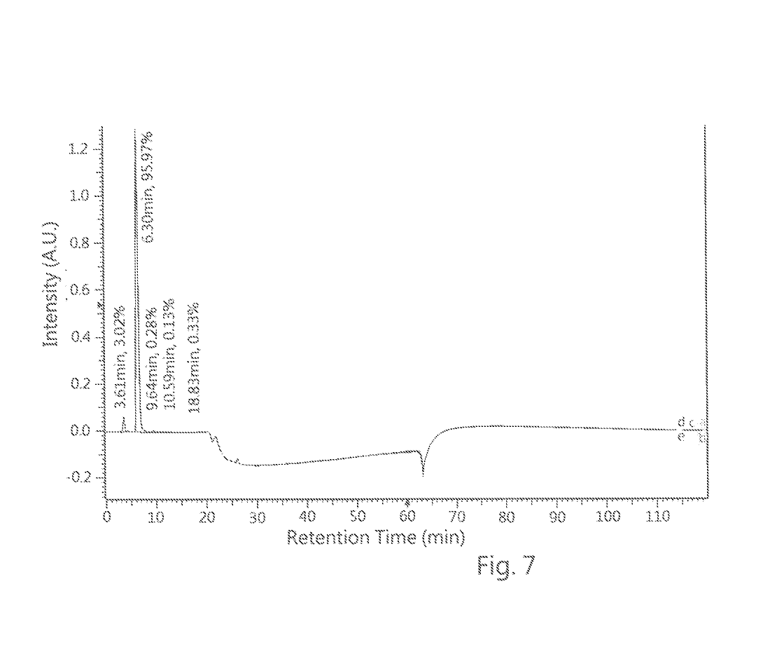

The operations and analysis of the intermediate 6 are performed in a 2.0 ml amber glass vial. Weight 4 mg intermediate 6 accurately and put the intermediate 6 into the 2.0 ml amber glass vial. Then add 1.8 ml methanol (HPLC grade). The initial condition is that methanol-0.1% trifluoroacetic acid solution (aqueous) (60:40, v/v) is used as the first eluent. Wait for 15 minutes. Then the first eluent is replaced by a second eluent, methanol-0.1% trifluoroacetic acid solution (aqueous) (99:1, v/v) in 30 seconds and wait for 40 minutes. Next the second eluent is changed into the first eluent- methanol-0.1% trifluoroacetic acid solution (aqueous) (60:40, v/v) in 30 seconds and wait for 64 minutes at last. The retention time of a characteristic peak (intermediate 6) is about 6.30 minutes. Refer to data in the following table 6 and the result in FIG. 7.

TABLE 6

| Time (min) | 0.5 | 15.0 | 15.5 | 55.5 | 56.0 | 120.0 |
|---|---|---|---|---|---|---|
| Trifluoroacetic acid | 40% | 40% | 1% | 1% | 40% | 40% |
| Methanol | 60% | 60% | 99% | 99% | 60% | 60% |

Take the intermediate 7 in the equation 2 as an example. The intermediate 7 is 3-(4-Chlorophenyl)-2-[[N-[2-[S-(4-methoxybenzyl)thio]-ethyl]amino]methyl]-8-aza-bicyclo[3.2.1]octane-[1R-(exo-exo)] and having the following structural formula.

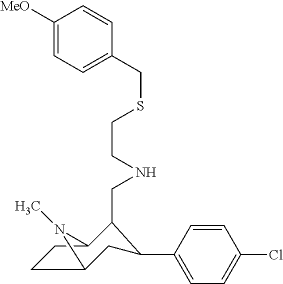 [SMILES: COc1ccc(CSCCNCC2C(c3ccc(Cl)cc3)CC3CCC2N3C)cc1]

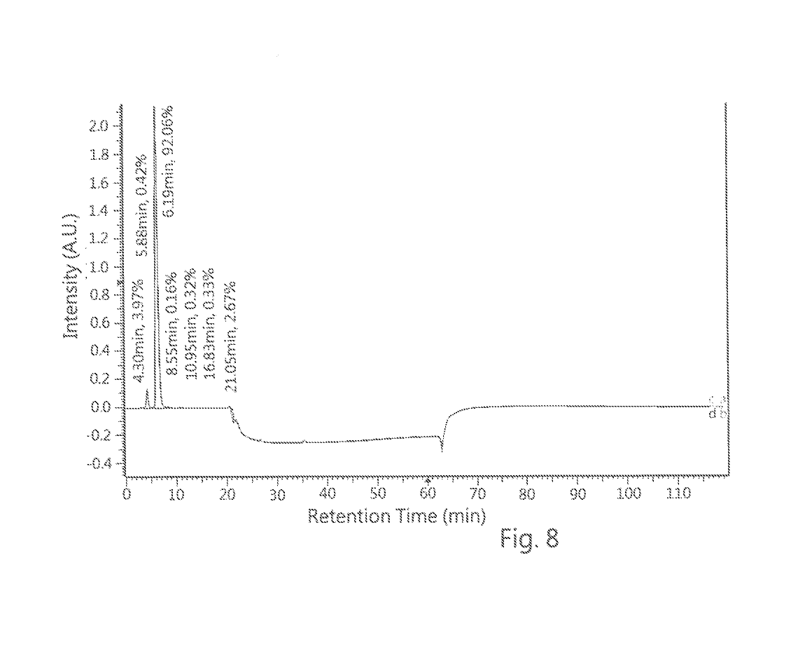

The operations and analysis of the intermediate 7 are performed in a 2.0 ml amber glass vial. Weight 3.3 mg intermediate 7 accurately and put the intermediate 7 into the 2.0 ml amber glass vial. Then add 1.8 ml methanol (HPLC grade). The initial condition is that methanol-0.1% trifluoroacetic acid solution (aqueous) (50:50, v/v) is used as the first eluent. Wait for 15 minutes. Then the first eluent is replaced by a second eluent, methanol-0.1% trifluoroacetic acid solution (aqueous) (99:1, v/v) in 30 seconds and wait for 40 minutes. Next the second eluent is changed into the first eluent- methanol-0.1% trifluoroacetic acid solution (aqueous) (50:50, v/v) in 30 seconds and wait for 64 minutes at last. The retention time of a characteristic peak (intermediate 7) is about 6.19 minutes. Refer to data in the following table 7 and the result in FIG. 8.

TABLE 7

| Time (min) | 0.5 | 15.0 | 15.5 | 55.5 | 56.0 | 120.0 |
|---|---|---|---|---|---|---|
| Trifluoroacetic acid | 50% | 50% | 1% | 1% | 50% | 50% |
| Methanol | 50% | 50% | 99% | 99% | 50% | 50% |

Take the intermediate 8 in the equation 2 as an example. The intermediate 8 is 2-[[[3-(4-Chlorophenyl)-8-methyl-8-azabicyclo[3.2.1]-oct-2-yl]methyl] [2[S-(4-methoxybenzyl)thio]ethyl]amino]-N-[2-[S-(4-methoxybenzyl)thio]ethyl]acetam ide-[1R-(exo-exo)] and having the following structural formula.

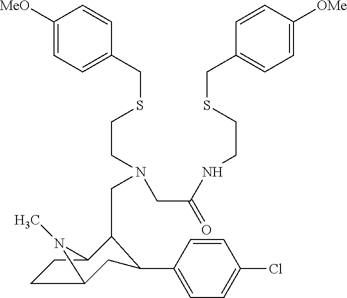 [SMILES: COc1ccc(CSCCNC(=O)CN(CCSCc2ccc(OC)cc2)CC2C(c3ccc(Cl)cc3)CC3CCC2N3C)cc1]

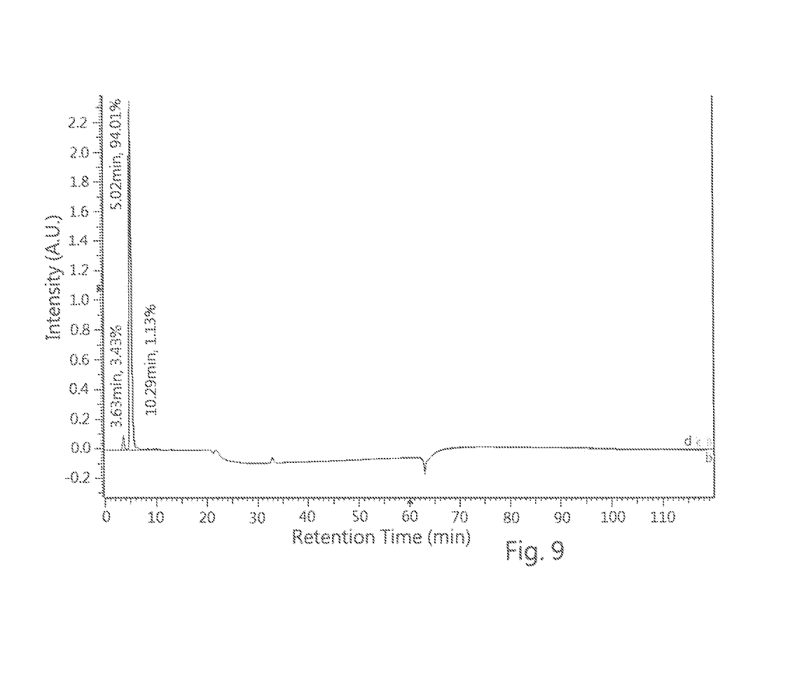

The operations and analysis of the intermediate 8 are performed in a 2.0 ml amber glass vial. Weight 4.5 mg intermediate 8 accurately and put the intermediate 8 into the 2.0 ml amber glass vial. Then add 1.8 ml methanol (HPLC grade). The initial condition is that methanol-0.1% trifluoroacetic acid solution (aqueous) (70:30, v/v) is used as the first eluent. Wait for 15 minutes. Then the first eluent is replaced by a second eluent, methanol-0.1% trifluoroacetic acid solution (aqueous) (99:1, v/v), in 30 seconds and wait for 40 minutes. Next the second eluent is changed into the first eluent- methanol-0.1% trifluoroacetic acid solution (aqueous) (70:30, v/v) in 30 seconds and wait for 64 minutes at last. The retention time of a characteristic peak (intermediate 8) is about 5.02 minutes. Refer to data in the following table 8 and the result in FIG. 9.

TABLE 8

| Time (min) | 0.5 | 15.0 | 15.5 | 55.5 | 56.0 | 120.0 |
|---|---|---|---|---|---|---|
| Trifluoroacetic acid | 30% | 30% | 1% | 1% | 30% | 30% |
| Methanol | 70% | 70% | 99% | 99% | 70% | 70% |

Take the intermediate 9 in the equation 2 as an example. The intermediate 9 is 2-[[2-[[[3-(4-Chlorophenyl)-8-methyl-8-azabi-cyclo[3.2.1]-oct-2-yl]methyl][[S-(4-methoxybenzyl)thio]ethyl]amino]ethyl]amino]-S-(4-methoxybenzyl)ethanethiol-[R-(exo-exo)] and having the following structural formula.

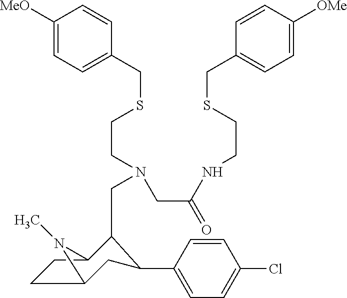 [SMILES: COc1ccc(CSCCNC(=O)CN(CCSCc2ccc(OC)cc2)CC2C(c3ccc(Cl)cc3)CC3CCC2N3C)cc1]

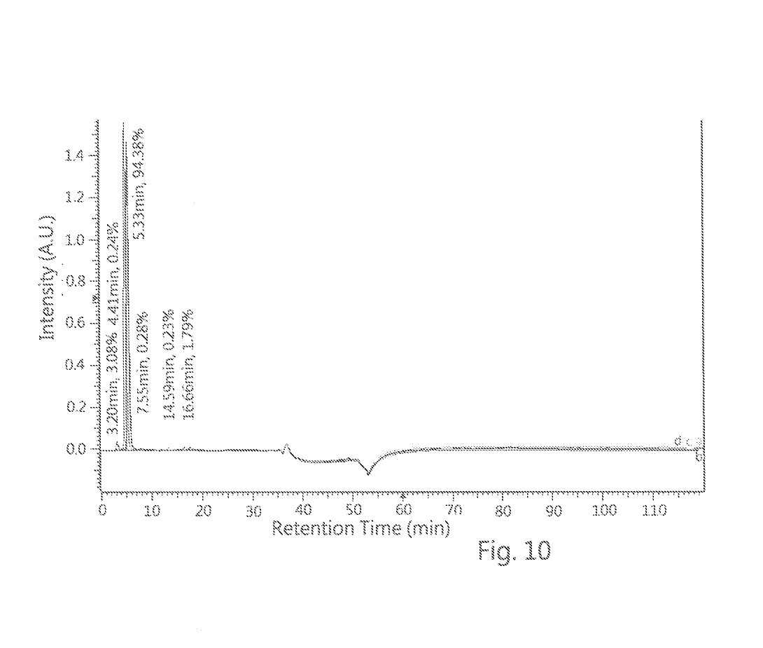

The operations and analysis of the intermediate 9 are performed in a 2.0 ml amber glass vial. Weight 4 mg intermediate 9 accurately and put the intermediate 9 into the 2.0 ml amber glass vial. Then add 1.8 ml methanol (HPLC grade). The initial condition is that methanol-0.1% trifluoroacetic acid solution (aqueous) (60:40, v/v) is used as the first eluent. Wait for 30 minutes. Then the first eluent is replaced by a second eluent, methanol-0.1% trifluoroacetic acid solution (aqueous) (99:1, v/v) in 30 seconds and wait for 15 minutes. Next the second eluent is changed into the first eluent- methanol-0.1% trifluoroacetic acid solution (aqueous) (60:40, v/v) in 30 seconds and wait for 74 minutes at last. The retention time of a characteristic peak (intermediate 9) is about 5.33 minutes. Refer to data in the following table 9 and the result in FIG. 10.

TABLE 9

| Time (min) | 0.5 | 30.0 | 30.5 | 45.5 | 46.0 | 120.0 |
|---|---|---|---|---|---|---|
| Trifluoroacetic acid | 40% | 40% | 1% | 1% | 40% | 40% |
| Methanol | 60% | 60% | 99% | 99% | 60% | 60% |

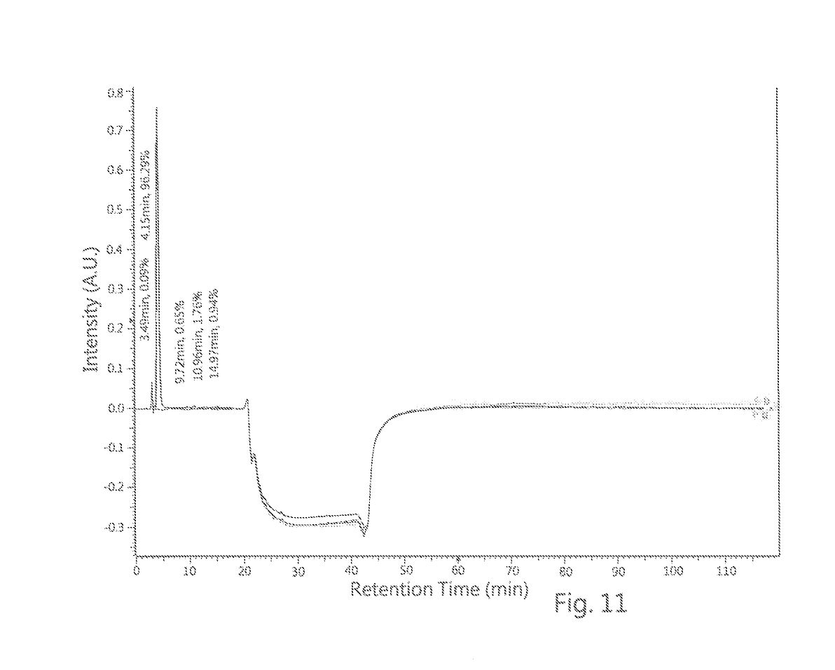

Take the imaging agent TRODAT-1 in the equation 2 as an example. The operations and analysis of TRODAT-1 are performed in a 2.0 ml amber glass vial. Weight 4 mg TRODAT-1 accurately and put the TRODAT-1 into the 2.0 ml amber glass vial. Then add 1.8 ml methanol (HPLC grade). The initial condition is that methanol-0.1% trifluoroacetic acid solution (aqueous) (45:55, v/v) is used as the first eluent. Wait for 15 minutes. Then the first eluent is replaced by a second eluent, methanol-0.1% trifluoroacetic acid solution (aqueous) (99:1, v/v), in 30 seconds and wait for 20 minutes. Next the second eluent is changed into the first eluent-methanol-0.1% trifluoroacetic acid solution (aqueous) (45:55, v/v) in 30 seconds and wait for 84 minutes at last. The retention time of a characteristic peak (imaging agent TRODAT-1) is about 4.15 minutes. Refer to data in the following table 10 and the result in FIG. 11.

TABLE 10

| Time (min) | 0.5 | 15.0 | 15.5 | 35.5 | 36.0 | 120.0 |
|---|---|---|---|---|---|---|
| Trifluoroacetic acid | 55% | 55% | 1% | 1% | 55% | 55% |
| Methanol | 45% | 45% | 99% | 99% | 45% | 45% |

Before analysis of the sample, the methanol-trifluoroacetic acid solution (aqueous) with the ratio of the initial condition (mobile phase) flows continuously for over 2 hours. Then use HPLC grade methanol as a blank sample to carry out HPLC analysis for at least three times. The results of three tests for blanks are compared to ensure there are no peaks that represent residual compounds of the previous analysis and then start to analyze the samples. Thereby accuracy of the analysis is ensured.

By the eluent containing a high proportion of methanol for elution and the mobile phase formed by different proportions of methanol and trifluoroacetic acid, the possibility of easily-retained substances remaining in the column is reduced. Moreover, the imaging agent, the precursor thereof or the intermediate thereof are retained in the column stably and the retention time of the reproductive characteristic peak is obtained. The gradient elution is introduced to elute low-polar impurities by using eluent having high ratio of methanol. Thus the reliability of analysis results is further improved.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A high performance liquid chromatography method for analyzing an imaging agent, a precursor of the imaging agent, or an intermediate of the imaging agent, wherein the imaging agent having a structural formula of: 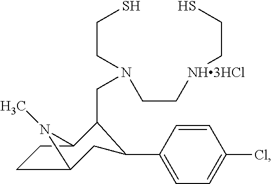
and the method comprising the steps of:
setting the imaging agent, a precursor of the imaging agent or an intermediate of the imaging agent into a chromatographic column;
using a first eluent for elution of the imaging agent, the precursor of the imaging agent or the intermediate of the imaging agent; the first eluent includes methanol and trifluoroacetic acid at a concentration of 0.5-1% by weight while a volume ratio of the methanol to the first eluent ranges from 5% to 70%;
using a second eluent for elution of the imaging agent, the precursor of the imaging agent or the intermediate of the imaging agent; the second eluent includes methanol and trifluoroacetic acid at a concentration of 0.5-1% by weight while a volume ratio of the methanol to the second eluent ranges from 95% to 99; and
using the first eluent again to elute the imaging agent, the precursor of the imaging agent or the intermediate of the imaging agent;
wherein a UV detector is used to record a chromatogram during the elution.

2. The method as claimed in claim 1, wherein in the step of using a first eluent for elution of the imaging agent, the precursor of the imaging agent or the intermediate of the imaging agent, time required for the elution is at least 20 minutes.

3. The method as claimed in claim 1, wherein in the step of using a second eluent for elution of the imaging agent, the precursor of the imaging agent or the intermediate of the imaging agent, time required for the elution is at least 15 minutes.

4. The method as claimed in claim 1, wherein in the step of using the first eluent again to elute the imaging agent, the precursor of the imaging agent or the intermediate of the imaging agent, time to elute is at least 60 minutes.

5. The method as claimed in claim 1, wherein a d etection wavelength of t he ultraviolet (UV) detector is set at 210 nm.

6. The method as claimed in claim 1, wherein the precursor of the imaging agent or the intermediate of the imaging agent is selected from the group consisting of
2-(S-4-Methoxybenzyl)thioethylamine, N-[2-(S-4-Methoxybenzyl)thioethyl]-2-chloroacetamide, (R)-(−)-Anhydroecgonine methyl ester, 2β-Carbomethoxy-3β-(4-chlorophenyl)tropane, 2β-Carboxy-3β-(4-chloropheny)tropane, 3-(4-Chlorophenyl)-N-[2[S-(4-methoxybenzyl)thio]-ethyl]-8-azabicyclo[3.2.1]-octane-2-carboxamide-[1R-(exo-exo)], 3-(4-Chlorophenyl)-2-[[N-[2-[S-(4-methoxybenzyl)thio]ethyl]amino]methyl]-8 -aza-bicyclo[3.2.1]octane-[1R-(exo-exo)], 2-[[[3-(4-Chlorophenyl)-8-methyl-8-azabicyclo[3.2.1]-oct-2-yl]methyl][2[S-(4-methoxybenzyl)thio]ethyl]amino]-N-[2-[S-(4- methoxybenzyl)thio]ethyl]acetamide-[1R-(exo-exo)], and 2-[[2-[[[3-(4-Chlorophenyl)-8-methyl-8-azabi-cyclo[3.2.1]-oct-2-yl]methyl][[S-(4-methoxybenzyl)thio]ethyl]amino]ethyl]amino]-S-(4-methoxybenzyl) ethanethiol-[1R-(exo-exo)].
